(19) United States
(12) Patent Application Publication
(10) Pub. No.: US 2006/0168277 A1
(43) Pub. Date: Jul. 27, 2006

(54) Traffic forwarding and conversion for supporting multiple advertising providers in video game advertising

(76) Inventors: Dhananjay Godse, Kanata (CA); Daniel Willis, Stittsville (CA); Gordon Freedman, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/303,972

(22) Filed: Dec. 19, 2005

Related U.S. Application Data
(60) Provisional application No. 60/636,536, filed on Dec. 17, 2004.

(51) Int. Cl. G06F 15/16; G06F 15/173

(52) U.S. Cl. 709/230; 709/238

(57) ABSTRACT

The present invention relates to a method and system for providing advertising content. A request is received for first advertising content according to a first advertising content request protocol. The first advertising content is then requested according to a second other advertising content request protocol. The first advertising content is received according to the second other advertising content request protocol and provided according to the first advertising content request protocol. The invention enables a game to communicate with a plurality of Ad Servers using different Ad Server Protocols, allowing a game publisher to mitigate the business risk by present ads from a plurality of advertising services.

This application claims benefit from U.S. Provisional application 60/636,536 filed Dec. 17, 2004.

### FIELD OF THE INVENTION

The instant invention generally relates to advertising on the Internet, and more specifically to a system and a method combining Internet computer gaming with Internet advertising.

### BACKGROUND OF THE INVENTION

One of the areas concerned with our modern social life that has received major impulses from World Wide Web (WWW) related developments, is computer gaming. Since its origins, dating back to the early seventies of the last century, computer gaming did not only undergo a period of substantial growth, but also radically changed its role in social interactions and interpersonal relationships. In our modern world, the computer gamer is no longer an isolated and introverted individual, but is part of a rich and active community of like-minded people. In recent times, the ongoing developments in the field of computer gaming led to the creation of new and exciting markets, as for example on-line computer gaming. The rapid expansion of the Internet provides not only the basis, but also the boost for the constant developments in computer gaming.

During the last couple of years, computer gaming has gained increasing popularity, and today ever increasing numbers of players are playing wit on-line enabled hardware platforms all around the world. A recent study has found that three-in-five Americans age six or older, or about 145 million people, say they routinely play computer or video games. Predictably, interactive computer gaming blurs the line between games and other entertainment or communication media, and the avenues explored in the development of gaming might well break new ground for interactive Internet applications in all areas of business relations and social life.

However, with all the positive features associated with the WWW, the Internet has its own share of problems. The general attitude towards the Internet exhibited by the common user of its services is that the Internet is free of charge, apart from minimal connection fees for the access provider. This as a consequence causes a considerable financial burden for many professional providers not of Internet access, but of Internet services. A common solution to this problem is Internet advertisement. Advertising holds the promise to be the ticket to prosperity for many Internet services. For an advertiser, the value of advertising is the ability to direct an advertisement to a specific group of consumers. Control over the advertisement in terms of when, where, how, and to whom an advertisement is communicated is of paramount importance to the advertiser. Targeted advertising, which offers compelling content aimed at a specific demographic market, will be the future in Internet advertising.

Due to their dynamic nature as well as due to their specific appeal to certain audiences, computer games and especially video games played on Internet enabled platforms provide the ideal vehicle for advertising. Not only is it possible for an advertiser to directly target a specific group of customers, but advertisements can be directly incorporated into the computer games, enabling an equivalent to the well-known concept of product placement.

In in-game advertising, for example, located at a user site is a gaming console in connection with at least a display, an interaction device such as a keyboard or a joystick, and a data storage device. During playing of a game, the game software contacts via the Internet a set of servers to retrieve advertising content for presentation to the user during game play. Data and advertising content is transferred over the Internet using an Ad Server Protocol. The advertising delivered to a game is controlled by the Ad Server. How and when ads are presented is controlled by the game. In exchange for presenting the advertisement in the game a game publisher receives a portion of the advertisement revenues.

To support a game accessing an Ad Server, a proprietary Ad Server Protocol is implemented by the game, which establishes a connection between the game site and the Ad Server. The game transfers information about the game and network identity to the Ad Server. The Ad Server uses this information for delivering advertising content to the game along with associated data. Optionally, the game collects information about which ads are presented at which place in the game, and transmits this information back to the Ad Server.

Unfortunately, once games are deployed, it is very difficult for the game publisher to change from the Ad Server Protocol of one advertising service to the Ad Server Protocol of another advertising service. This results in a substantial business risk for the game publisher. For example, in a case where the advertising sales service is unable to provide sufficient revenues or appropriate advertising content, the game publisher is already exclusive to the particular advertising sales service. This is similar to the risk faced by a manufacturer of having a component provided by only one supplier but with the additional risk that whereas the component can be thoroughly tested before selection, the advertising sales arise after the software development is completed. Manufacturers mitigate the component risk by having at least two suppliers of the component in case one of the suppliers has difficulty meeting an order for any reason.

It would be desirable to provide a method and system for enabling a game to communicate with a plurality of Ad Servers using different Ad Server Protocols, allowing a game publisher to mitigate the business risk by presenting ads from a plurality of advertising services.

### SUMMARY OF THE INVENTION

It is, therefore, an object of the invention to provide a method and system for enabling a game to communicate with a plurality of Ad Servers using different Ad Server Protocols.

In accordance with the present invention there is provided a method for providing advertising content. A request is received for first advertising content according to a first advertising content request protocol. The first advertising content is then requested according to a second other advertising content request protocol. The first advertising content is received according to the second other advertising content request protocol and provided according to the first advertising content request protocol.

In accordance with the present invention there is further provided a system for providing advertising content. The system comprises a port for being connected to a communication network and a processor connected to the port for performing:

receiving a request for advertising content according to a first advertising content request protocol;

requesting advertising content according to a second other advertising content request protocol;

receiving the advertising content according to the second other advertising content request protocol; and,

providing the advertising content according to the first advertising content request protocol.

In accordance with the present invention there is yet further provided a system for providing advertising content. The system comprises a port for being connected to a communication network and a processor connected to the port for performing:

receiving a request for advertising content according to a first advertising content request protocol;

receiving the advertising content according to the first advertising content request protocol;

converting the advertising content according to the first advertising content request protocol into advertising content according to a second other advertising content request protocol; and,

providing the advertising content according to the second other advertising content request protocol.

In accordance with the present invention there is yet further provided a storage medium having stored therein executable commands for execution on a processor, the processor when executing the commands performing:

receiving a request for advertising content according to a first advertising content request protocol;

requesting advertising content according to a second other advertising content request protocol;

receiving the advertising content according to the second other advertising content request protocol; and,

providing the advertising content according to the first advertising content request protocol.

In accordance with the present invention there is yet further provided a storage medium having stored therein executable commands for execution on a processor, the processor when executing the commands performing:

receiving a request for advertising content according to a first advertising content request protocol;

receiving the advertising content according to the first advertising content request protocol;

converting the advertising content according to the first advertising content request protocol into advertising content according to a second other advertising content request protocol; and,

providing the advertising content according to the second other advertising content request protocol.

In accordance with the present invention there is provided a method for providing advertising content comprising: a) receiving a first report relating to first advertising content according to a first advertising content reporting protocol; and, b) providing a second report comprising at least some information from the report according to a second other advertising content reporting protocol.

### BRIEF DESCRIPTION OF THE DRAWINGS

Embodiments of the instant invention will now be described in conjunction with the following drawings, in which:

FIG. 1 is a simplified block diagram illustrating a game computer connected to Ad Servers via a communication network;

FIG. 2a is a schematic sequence diagram illustrating communication between a processor of the game computer and an Ad Server using Protocol A;

FIG. 2b is a schematic sequence diagram illustrating communication between a processor of the game computer and an Ad Server using Protocol B;

FIG. 3 is a simplified block diagram illustrating a game computer connected to Ad Servers via a communication network and a translator according to the invention;

FIG. 4 is a schematic sequence diagram illustrating communication between the processor of the game computer and the Ad Server via the translator according to the invention;

FIG. 5 is a simplified flow diagram illustrating a first embodiment of a method for providing advertising content according to the invention;

FIG. 6 is a simplified flow diagram illustrating a second embodiment of a method for providing advertising content according to the invention;

FIG. 7 is a simplified flow diagram illustrating a third embodiment of a method for providing advertising content according to the invention;

FIG. 8 is a simplified flow diagram illustrating a fourth embodiment of a method for providing advertising content according to the invention;

FIG. 9 is a schematic sequence diagram illustrating communication between the processor of the game computer and the Ad Server via a translator embedded into the game according to the invention; and,

FIG. 10 is a schematic sequence diagram illustrating communication between the processor of the game computer and the Ad Server via a translator embedded into the Ad Server according to the invention.

### DETAILED DESCRIPTION OF THE INVENTION

Embodiments of the instant invention are now described, all of which relate to the translation of advertising content request protocols. While the embodiments will be described in combination with advertising in video games executed on Internet enabled platforms, it will readily become apparent to those of skill in the art that the instant invention is not limited thereto.

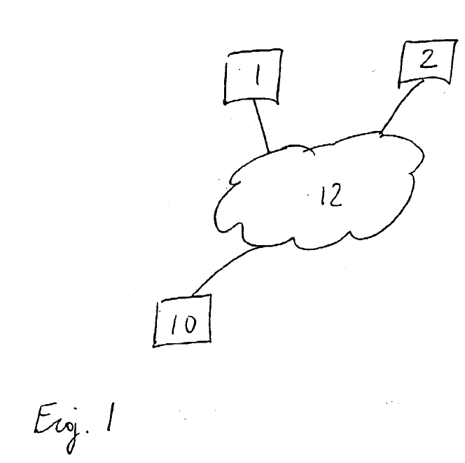

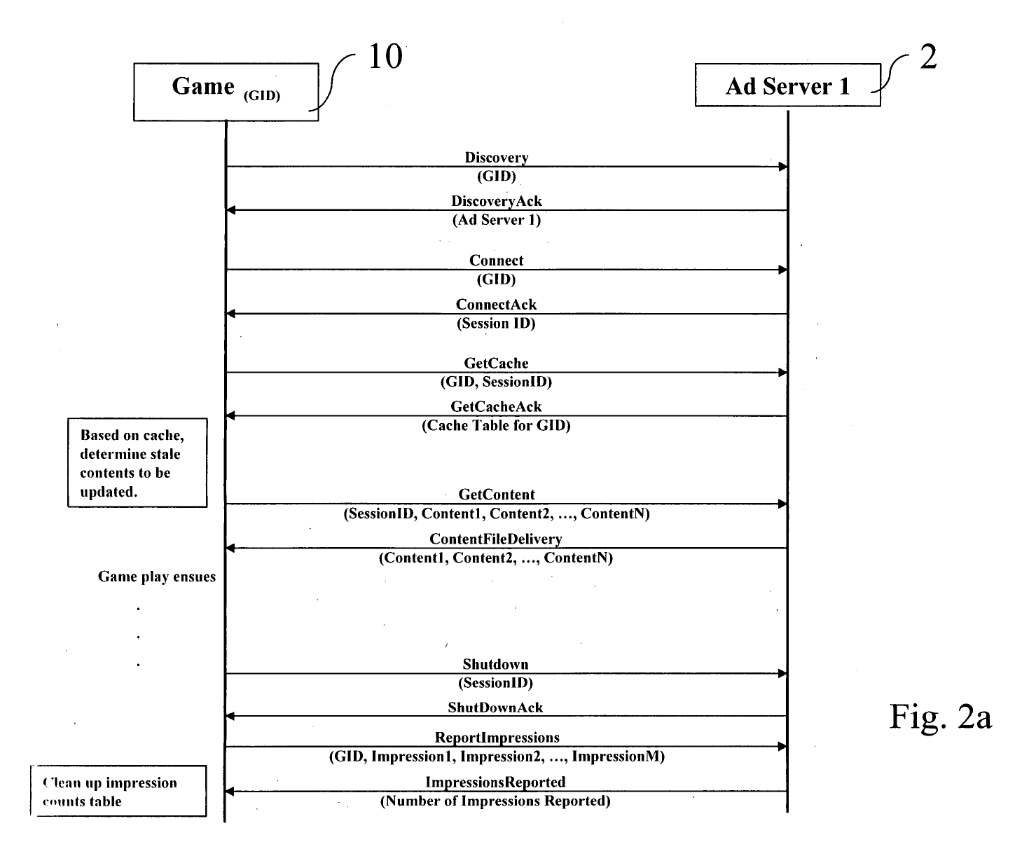

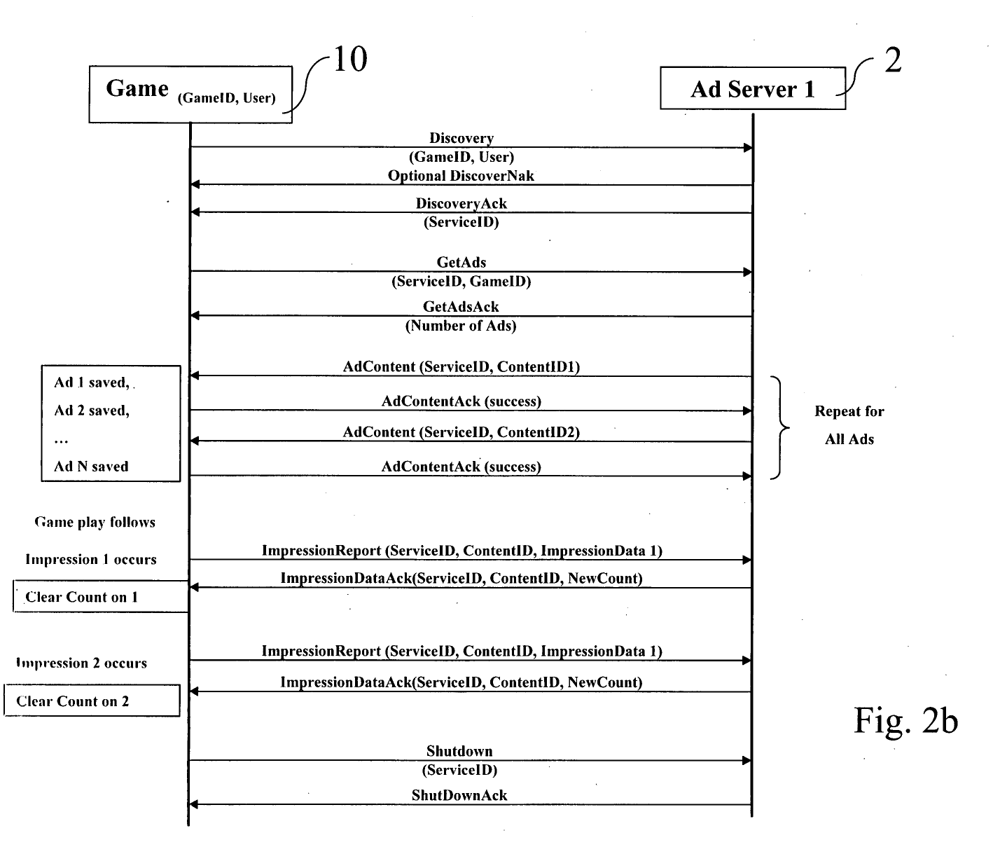

FIG. 1 shows a game computer 10 connected to an Internet Protocol (IP) network 12 including, for example, Broad Band Access (BAN), Access Aggregation Network (AAN), and Wide-Area Networking facilities (WAN). Also connected to the network 12 are a first Ad Server 1 and a second Ad Server 2. FIG. 2a schematically illustrates in a sequence diagram communication between a processor of the game computer 10 and Ad Server 1 while executing a first game using a first advertising content request protocol A, in the following referred to as Protocol A. Presently, numerous different protocols are in use for enabling communication between various sites connected to a communication network. For example, while executing a different second game the processor of the game computer 10 communicates with Ad Server 2 using a second advertising content request protocol B, in the following referred to as Protocol B, as shown in the sequence diagram of FIG. 2b. Obviously, the two Protocols have major differences. For example, according to the Protocol A, a cache table is transmitted followed by a message comprising a plurality of different ad contents while according to the Protocol B the different ad contents are transmitted separately in succession. Further, according to the Protocol A reports of different impressions are transmitted in a single impression report while according to the Protocol B each of the different impressions is reported separately as an impression report.

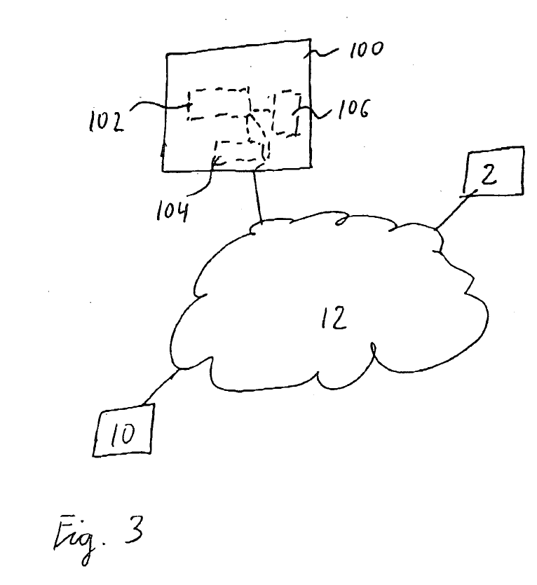

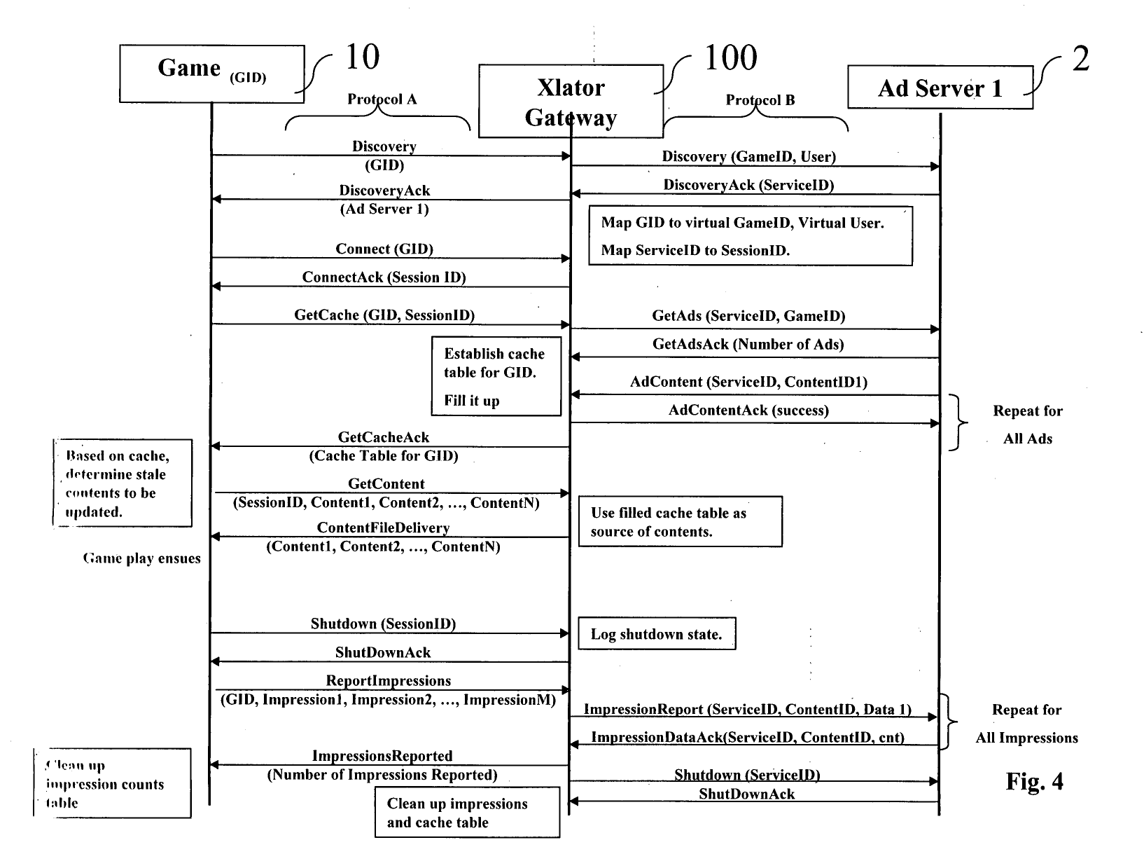

Referring to FIG. 3 a simplified block diagram of a protocol translator 100 according to the invention is shown. The protocol translator 100 enables, for example, a processor of the game computer 10 using Protocol A for communication while executing a game to communicate with the Ad Server 2 which uses Protocol B for communication. Both protocols involve transferring network identity, game information, ad spot information, and statistics from the game to the Ad Server, and transferring ad content, and storage and presentation policy from the Ad Server to the game. FIG. 4 schematically illustrates in a sequence diagram communication between the processor of the game computer 10 executing the first game and the Ad Server 2. As shown in FIG. 4, the processor of the game computer 10 communicates via the communication network 12 with the translator 100 using Protocol A, while the translator 100 communicates with the Ad Server 2 using Protocol B. The translator 100 receives a request for advertising content. The request includes, for example, game information, network identity, and ad spot information and is transmitted as a single message or a set of several messages. The translator 100 translates the request with appropriate changes in format, security, and identity according to the Protocol B and transmits the request to the Ad Server 2. The Ad Server 2 then transmits a set of messages to the translator comprising ad content, and optionally information relating to storage and presentation policy. Upon receipt, the translator 100 translates the messages with appropriate changes in format, security, and identity according to Protocol A and transmits the translated messages to the processor of the game computer 10.

In its simplest form, the translator 100 comprises only a processor 102 for translating commands of the messages received and passing on data. In operation, the commands of the messages are translated as they are received by the processor 102 and transmitted to their destination, while the data are passed through accordingly, requiring only network bandwidth. However, such a translation process is only possible when the two Protocols are truly directly correlated in all aspects. When this is not the case and one Protocol has features or supports data which are unsupported by the other, the processor 102 executes two separate processes, a first process using Protocol A for communication with the processor of the game computer 10 and a second process using Protocol B for communication with the Ad Server 2. The first and the second process are simultaneously operated as separate processes on the processor 102 of the translator 100 with data being passed between the processes through shared memory 104 such as common caches or stacks, or through a third protocol. The first and the second process are performed on the processor 102 by, for example, executing commands stored in memory 106.

The following examples illustrate the operation of the translator 100 when one Protocol has features or supports data which are unsupported by the other. Referring to the Protocols A and B above, the translator 100 stores, upon receipt from the Ad Server 2, the different ad contents in memory, creates then a cache table and transmits the cache table as a first message and the different ad contents together in a second message to the game computer 10. With respect to the impressions, the translator 100 receives the different impressions in a single report from the game computer 10, processes the report to create a plurality a plurality of impression reports—one report for each impression—and transmits the same sequentially to the Ad Server 2.

Further, it is possible that the two processes engage in functions that are not supported by both protocols. For example, a game reports according to Protocol A metrics including impression count, average impression time, obfuscating data, and size information while the Protocol B of the Ad Server only supports impression count. Here the translator 100 receives the full set of data according to Protocol A but passes on only the impression count to the Ad Server. As such, the full features supported by the game side Protocol A are only partially implemented in the communication with the Ad Server according to the Protocol B. Optionally, the translator 100 reports, for example, the full set of data to a metrics monitoring company and/or to the advertiser. Conversely, if the Protocol B supports a handshake or requires more data than the game according to Protocol A provides, the translator 100 performs the handshake or fills in the missing data when possible while the game remains oblivious to this data.

In another example, Protocol B does not support security while Protocol A does. Here, the translator 100 implements security for the communication with the game computer 10 according to Protocol A.

Finally, the Protocol A requires ads in a specific format whereas the Protocol B provides ads with format data. Here, the translator 100 reformats the ad data to the specific format before providing the same to the game computer 10. Similarly, when the game provides 20 values for metrics according to Protocol A while the Protocol B supports only 4 values derivable from the 20 values, the translator 100 determines 4 values from the 20 values and transmits them according to Protocol B to the Ad Server.

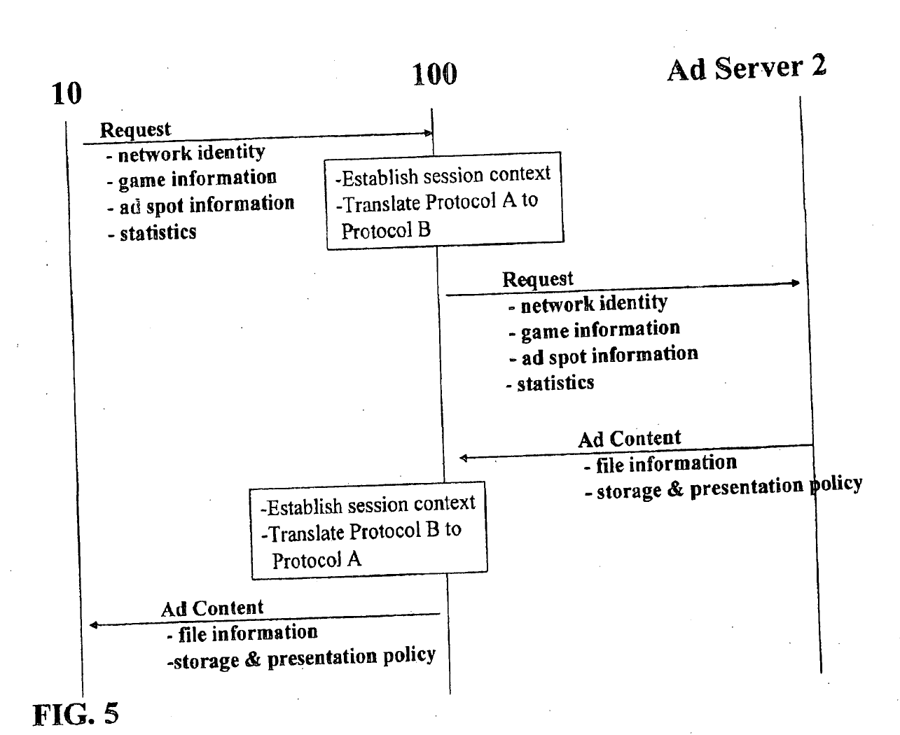

Referring to FIG. 5, a simplified flow diagram illustrates a first embodiment of a method for providing advertising content according to the invention using the translator 100. While executing a game a processor of the game computer 10 using Protocol A for communication requests Ad Content. It further provides game information, network identity, ad spot information, and statistics. These messages are transmitted to the translator 100 using Protocol A. The translator 100 translates the messages into messages with appropriate changes in format, security, and identity according to the Protocol B and transmits the same to the Ad Server 2. The Ad Server 2 responds and transmits messages containing ad content and possibly information relating to storage and presentation policy to the translator 100 according to Protocol B. Upon receipt the translator 100 translates the messages with appropriate changes in format, security, and identity according to the Protocol A and transmits the translated messages to the game computer 10.

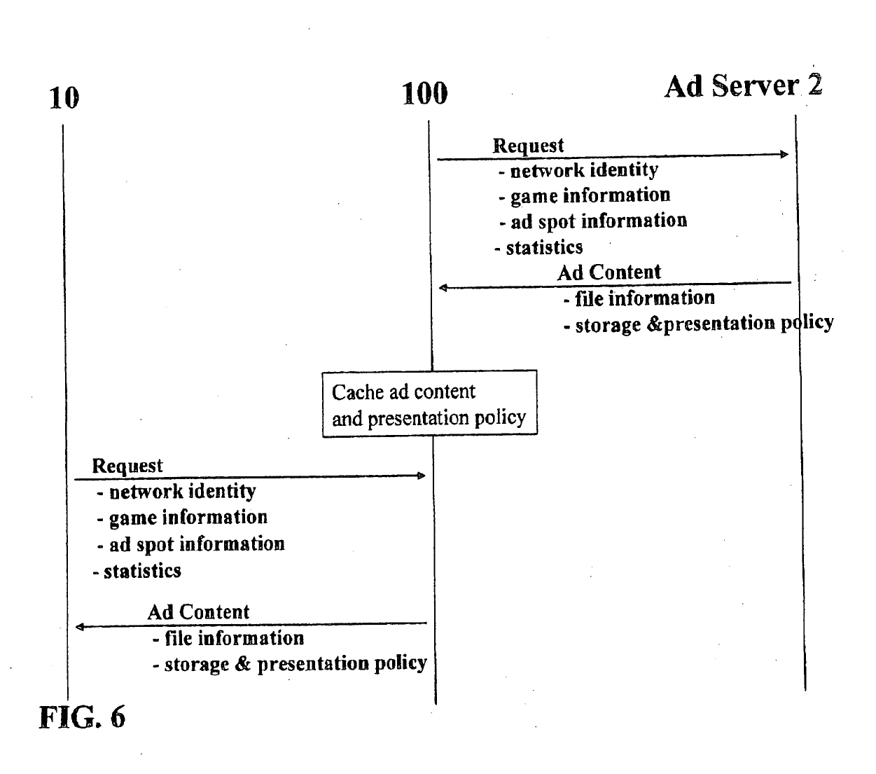

Referring to FIG. 6, a second embodiment of a method for providing advertising content using the translator 100 is shown. The interactions are similar to the first method; however, the translator 100 acts as a client of the Ad Server 2 and downloads and caches the ad content, storage and presentation policy. This reduces latency experienced by the game in receiving ad content, and ad content traffic from the Ad Server 2 to the translator 100.

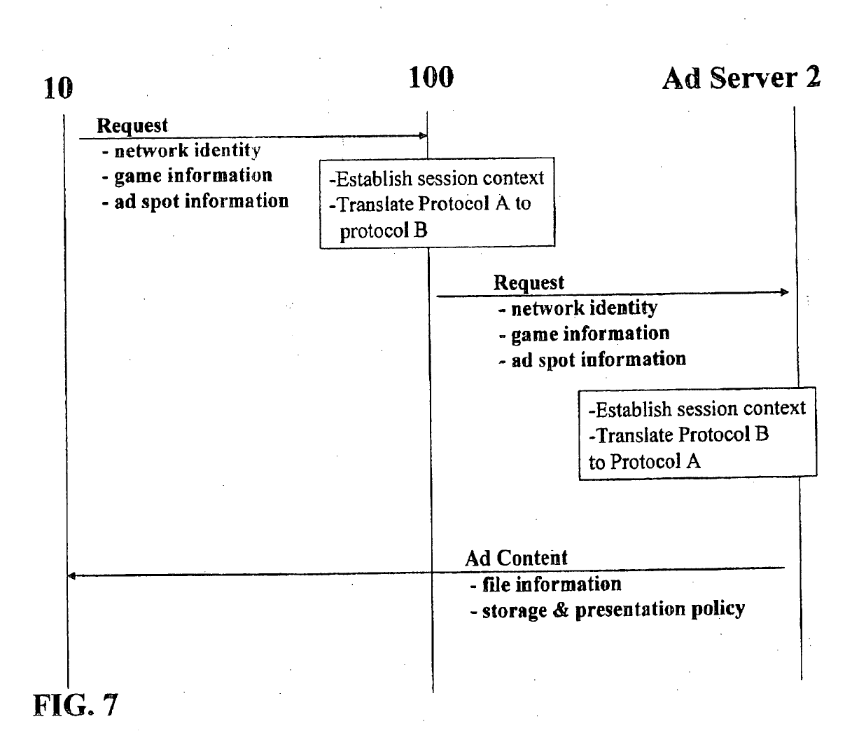

In a third embodiment of a method for providing advertising content, shown in FIG. 7, the translator 100 translates the messages received from the game computer 10 and transmits the translated messages to the Ad Server 2, while the Ad Server 2 responds directly to the game computer 10. This method provides an operator of the Ad Server 2 with more information about which games are drawing ad content from the Ad Server 2. However, in this case a processor of the Ad Server 2 has to translate the messages according to the Protocol A prior to transmitting same to the game computer 10.

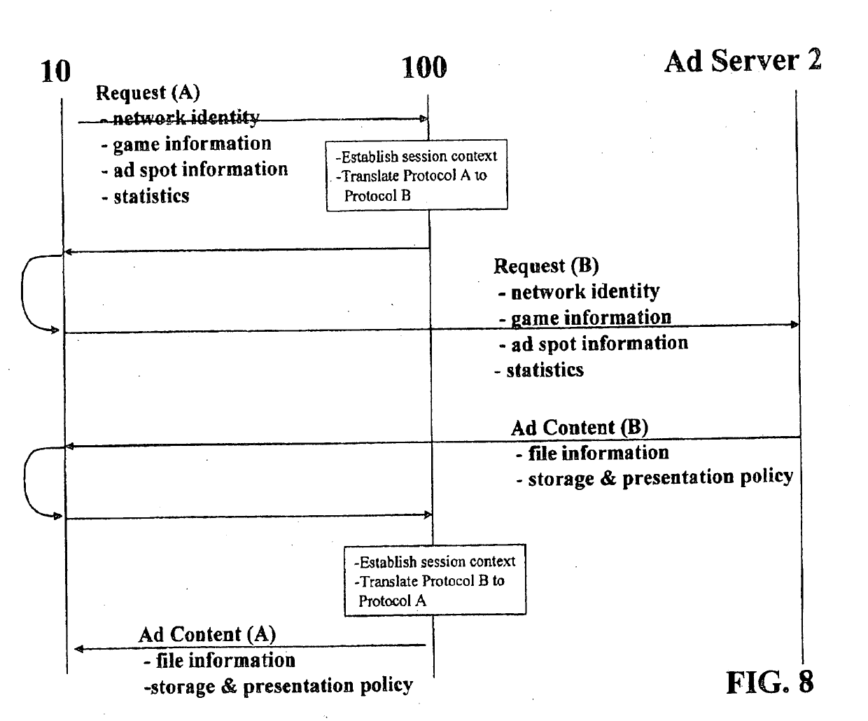

Referring to FIG. 8, a fourth embodiment of a method for providing advertising content using the translator 100 is shown. The interactions are similar to the first embodiment; however, communication between the translator 100 and the Ad Server 2 is via the game computer 10. This enables the game computer 10 to appear to communicate with the Ad Server 2 even if it does communicate using a different protocol.

In a further embodiment, messages transmitted according to Protocol A are messages according to Protocol B encapsulated in a Protocol A envelope. In this case the translation comprises removal of the envelope, for example, a protocol header for the translation from Protocol A to Protocol B, and adding of the envelope for the reverse translation from Protocol B to Protocol A.

There are numerous possibilities to implement the translator 100 into a communication network 12. The translator 100 belongs to a broker system linking different games of different game publishers to various Ad Servers using different Protocols for communication. The broker system employs, for example, a plurality of translators 100 for enabling translation between two of a plurality of different protocols or, alternatively, the processor 102 of the translator 100 is capable of translating between two of a plurality of different protocols. Here, the translator 100 is advantageous for a broker by enabling communication with game computers and Ad Servers using different protocols. But it is also advantageous for game publishers, enabling the game publisher to design, manufacture and sell a game using one protocol, but being able to draw ad content from various Ad Servers using different Protocols. This allows a game publisher to mitigate the business risk by presenting ads from a plurality of advertising services.

Optionally, the translator 100 is embedded in the Ad Server 1 used, for example, in a broker system. For example, the Ad Server includes computers from a content caching and edge processing network such as Akamai or Speedera. In such a case, it is possible to execute the protocol translation on one of these processors and still be a full member of the Ad Server. Embedding the translator 100 in the Ad Server 1 allows the broker to store, for example, most frequently used ad content in the Ad Server 1 and to provide it without having to communicate with other Ad Servers reducing response times. Further, the game computer is enabled to draw ad content from more than one Ad Server during a same session. The Ad Server 1 is, for example, configured to draw content from one server or the other based on the ad spots for which the content is requested.

Additionally, if the Ad Server 1 comprising the translator is provisioned to enable or disable content to any ad spot in a game after the game has been deployed it is possible to use the translator to remove ad content received from a second Ad Server for ad spots that are not enabled as a part of the protocol translation process. This is also applicable in the third embodiment shown in FIG. 7 since translation software executed in the second Ad Server includes configuration data for ad spots that are enabled.

Further optionally, the translator 100 keeps a record of active games by, for example, storing an encrypted network identity, game information, and geo-location and time stamp of each game that contacts the translator 100 independent from which Ad Server the ad content is drawn. This information is made available in the first set of content request messages from the game computer to the translator 100.

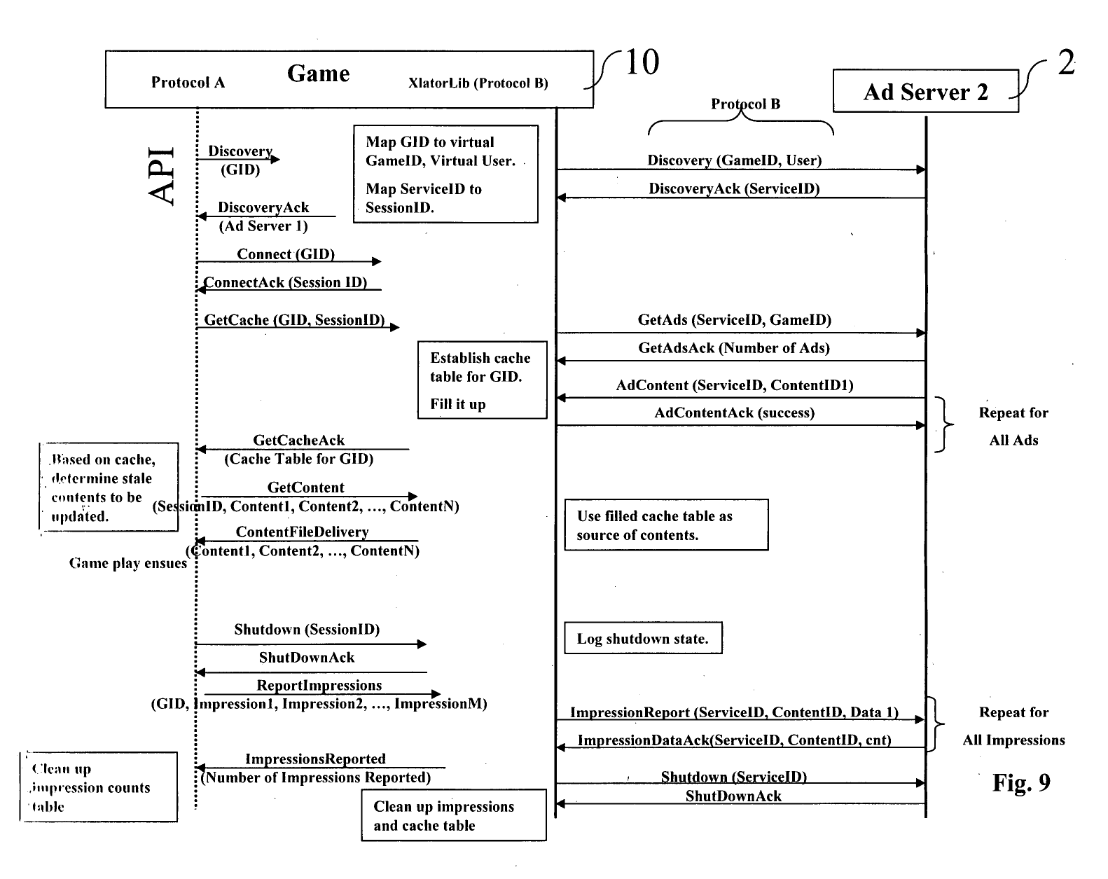

FIG. 9 schematically illustrates in a sequence diagram communication between a processor of the game computer 10 and Ad Server 2 while executing a game. Here the translator is embedded into the game software and is executed by the processor of the game, computer. As shown in FIG. 9, the translator communicates with the Application Program Interface (API) using Protocol A and translates the messages according to Protocol B, enabling communication of the game using Protocol A with Ad Server 2 using Protocol B. This allows a game publisher to use one Protocol for the game internally but enables the game to communicate with other systems using a different protocol. Furthermore, it enables the game to provide impressions to a metrics monitoring service using a different protocol. Optionally, the translator is capable of translating the internal game protocol into a plurality of different protocols. Further optionally, the translator is upgraded to translate into a further protocol by downloading software via the communication network from the game publisher to the game computer. Preferably, the upgrade is performed automatically in the background while the game computer is connected to the computer network during a game session. Preferably, the translator is executed within a thin client in execution on the gaming system and other than integrated within the game allowing updating of the translator without affecting the video game software.

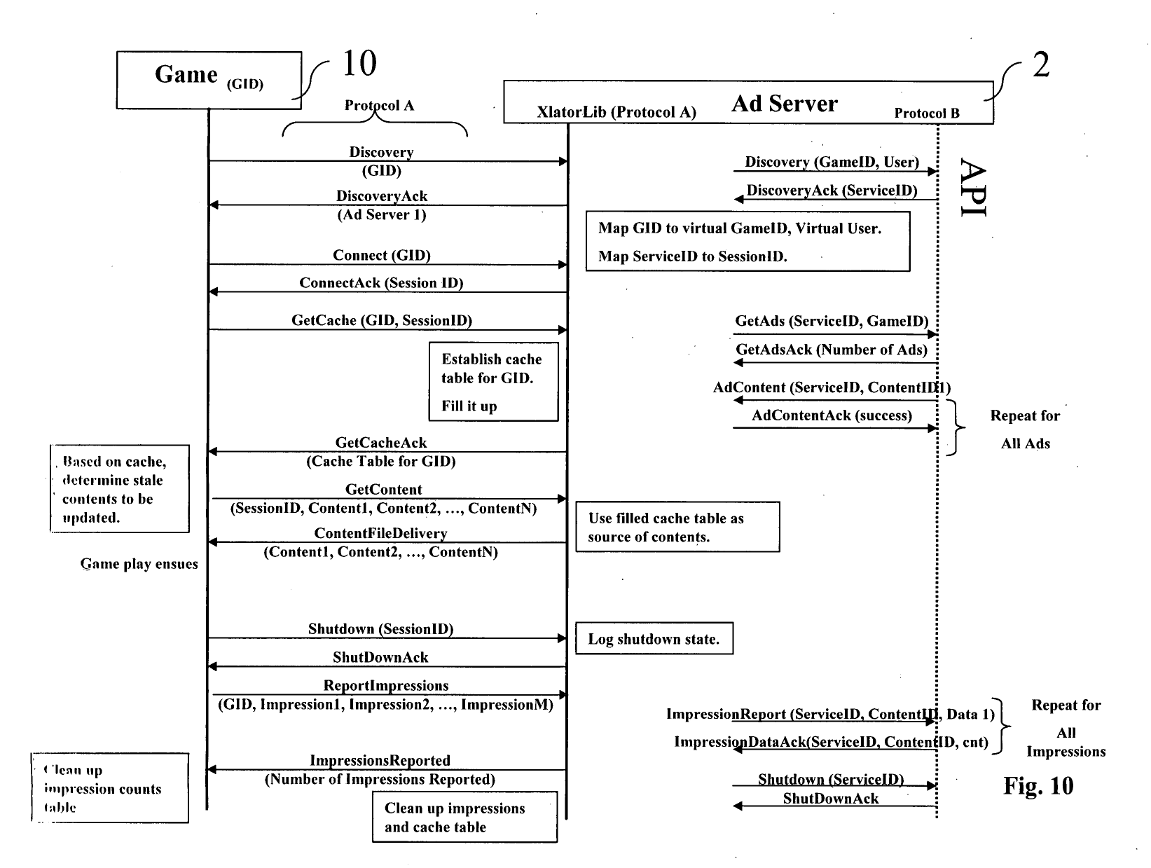

FIG. 10 schematically illustrates in a sequence diagram communication between a processor of the game computer 10 and Ad Server 2 while executing a game. Here the translator is embedded into the Ad Server 2 and is executed by the processor of the Ad Server 2.

As shown in FIG. 10, the translator communicates with the API using Protocol B and translates the messages according to Protocol A, enabling communication of the Ad Server 2 using Protocol B with the game using Protocol A. This enables the Ad Server to use one Protocol internally but enables communication with other systems using a different protocol or a plurality of different protocols.

Numerous other embodiments of the invention will be apparent to persons skilled in the art without departing from the spirit and scope of the invention as defined in the appended claims.

What is claimed is:

1. A method for providing advertising content comprising:
a) receiving a request for first advertising content according to a first advertising content request protocol;
b) requesting the first advertising content according to a second other advertising content request protocol;
c) receiving the first advertising content according to the second other advertising content request protocol; and,
d) providing the first advertising content according to the first advertising content request protocol.

2. A method for providing advertising content as defined in claim 1 comprising:
receiving metrics according to the first advertising content request protocol; and,
providing the metrics according to the second other advertising content request protocol.

3. A method for providing advertising content as defined in claim 2 comprising:
providing the metrics according to a third other advertising content request protocol.

4. A method for providing advertising content as defined in claim 1 comprising:
e) receiving the request for the first advertising content according to the second other advertising content request protocol; and,
f) providing the first advertising content according to the second other advertising content request protocol.

5. A method for providing advertising content as defined in claim 4 wherein a) to d) are performed using a first processor, and wherein e) and f) are performed using a second processor, the method comprising:
providing from a third processor to the first processor a request for the first advertising content according to a first advertising content request protocol.

6. A method for providing advertising content as defined in claim 5 wherein the first and the second processor are part of a first and a second system, respectively, the first and the second system being connected to a communication network, and wherein the requests and the advertising content are transmitted via the communication network.

7. A method for providing advertising content as defined in claim 6 wherein the first system executes the first advertising content request protocol and the second system executes the second other advertising content request protocol.

8. A method for providing advertising content as defined in claim 7 comprising:
receiving metrics according to the first advertising content request protocol; and,
providing the metrics according to a third other advertising content request protocol to a fourth processor connected to the communication network.

9. A method for providing advertising content as defined in claim 8 wherein the fourth processor is part of a metrics monitoring system.

10. A method for providing advertising content as defined in claim 6 wherein the first system is a broker system.

11. A method for providing advertising content as defined in claim 7 wherein the third processor is in execution of a video game.

12. A method for providing advertising content as defined in claim 7 comprising storing the advertising content in memory of the first system.

13. A method for providing advertising content as defined in claim 7 comprising:
a1) converting the request; and,
c1) converting the advertising content.

14. A method for providing advertising content as defined in claim 13 wherein a1) the request is converted by removing a first advertising content request protocol envelope, and wherein c1) the advertising content is converted by adding the first advertising content request protocol envelope.

15. A method for providing advertising content as defined in claim 13 comprising:
a2) transmitting the converted request to a third processor.

16. A method for providing advertising content as defined in claim 15 wherein c) the advertising content is received from the third processor.

17. A method for providing advertising content as defined in claim 16 wherein a) the request is received from the third processor.

18. A method for providing advertising content as defined in claim 7 wherein the request comprises ad spot information and wherein b) to f) are performed in dependence upon the ad spot information.

19. A method for providing advertising content as defined in claim 13 wherein the first advertising content request protocol comprises a first set of commands and data and the second advertising content request protocol comprises a second set of commands and data, and wherein each command of the first set is converted into a corresponding command of the second set, and wherein the data thereof are passed on accordingly.

20. A method for providing advertising content as defined in claim 13 wherein the first processor executes a first process using the first advertising content request protocol and a second process using the second other advertising content request protocol.

21. A method for providing advertising content as defined in claim 20 wherein the first and the second process are separate processes.

22. A method for providing advertising content as defined in claim 21 wherein the first and the second process are simultaneously operated.

23. A method for providing advertising content as defined in claim 22 wherein data are passed between the first and the second process using shared memory.

24. A method for providing advertising content as defined in claim 23 wherein data are passed between the first and the second process using a third other protocol.

25. A method for providing advertising content comprising:
a) receiving a request for advertising content according to a first advertising content request protocol;
b) requesting advertising content according to a second other advertising content request protocol;
c) receiving the request for advertising content according to the second other advertising content request protocol; and,
d) providing the advertising content according to the first advertising content request protocol.

26. A method for providing advertising content as defined in claim 25 comprising:
a1) converting the request; and,
c1) converting advertising content according to the second other advertising content request protocol into the advertising content according to the first advertising content request protocol.

27. A method for providing advertising content as defined in claim 26 wherein a), a1) and b) are performed using a first processor, and wherein c), c1) and d) are performed using a second processor.

28. A method for providing advertising content as defined in claim 27 wherein the first and the second processor are part of a first and a second system, respectively, the first and the second system being connected to a communication network, and wherein the requests and the advertising content are transmitted via the communication network.

29. A method for providing advertising content as defined in claim 28 wherein the first system executes the first advertising content request protocol and the second system executes the second other advertising content request protocol.

30. A method for providing advertising content as defined in claim 28 wherein the first system is a broker system.

31. A method for providing advertising content as defined in claim 29 wherein a) the request is received from a game processor executing a game.

32. A system for providing advertising content comprising:
a port for being connected to a communication network; and,
a processor connected to the port for performing:
receiving a request for advertising content according to a first advertising content request protocol;
requesting advertising content according to a second other advertising content request protocol;
receiving the advertising content according to the second other advertising content request protocol; and,
providing the advertising content according to the first advertising content request protocol.

33. A system for providing advertising content as defined in claim 32 comprising memory connected to the processor for storing the advertising content.

34. A system for providing advertising content comprising:
a port for being connected to a communication network; and,
a processor connected to the port for performing:
receiving a request for advertising content according to a first advertising content request protocol;
receiving the advertising content according to the first advertising content request protocol;
converting the advertising content according to the first advertising content request protocol into advertising content according to a second other advertising content request protocol; and,
providing the advertising content according to the second other advertising content request protocol.

35. A system for providing advertising content as defined in claim 34 comprising memory connected to the processor for storing the advertising content.

36. A storage medium having stored therein executable commands for execution on a processor, the processor when executing the commands performing:
a) receiving a request for advertising content according to a first advertising content request protocol;
b) requesting advertising content according to a second other advertising content request protocol;
c) receiving the advertising content according to the second other advertising content request protocol; and,
d) providing the advertising content according to the first advertising content request protocol.

37. A storage medium as defined in claim 36 wherein the processor when executing the commands performs:
receiving metrics according to the first advertising content request protocol; and,
providing the metrics according to the second other advertising content request protocol.

38. A storage medium as defined in claim 37 wherein the processor when executing the commands performs:
providing the metrics according to a third other advertising content request protocol.

39. A storage medium as defined in claim 36 wherein the processor when executing the commands performs:
storing the advertising content in memory connected to the processor.

40. A storage medium as defined in claim 39 wherein the processor when executing the commands performs:
a1) converting the request; and,
c1) converting the advertising content.

41. A storage medium as defined in claim 40 wherein the processor when executing the commands performs:
simultaneously executing a first process using the first advertising content request protocol and a second process using the second other advertising content request protocol.

42. A storage medium having stored therein executable commands for execution on a processor, the processor when executing the commands performing:
receiving a request for advertising content according to a first advertising content request protocol;
receiving the advertising content according to the first advertising content request protocol;
converting the advertising content according to the first advertising content request protocol into advertising content according to a second other advertising content request protocol; and,
providing the advertising content according to the second other advertising content request protocol.

43. A method for providing advertising content comprising:
a) receiving a first report relating to first advertising content according to a first advertising content reporting protocol; and,
b) providing a second report comprising at least some information from the report according to a second other advertising content reporting protocol.

44. A method according to claim 43 comprising:
providing a third report comprising information including information other than within the second report.

45. A method according to claim 44 wherein the first report is provided from a video game processing system to a first server, the second report is provided from the first server to a second other server and the third report is provided from the first server to a metrics server.

46. A method according to claim 43 wherein the first report is provided from a video game processing system to a first server, the second report is provided from the first server to a second other server.

47. A method according to claim 43 comprising:
providing a third report comprising information relating to data absent from the first report.

48. A method according to claim 47 wherein the first report is provided from a video game processing system to a first server, the second report is provided from the first server to a second other server and the third report is provided from the first server to a metrics server.
